(19) United States
(12) Patent Application Publication
(10) Pub. No.: US 2016/0356019 A1
(43) Pub. Date: Dec. 8, 2016

(54) UNMANNED CONTROL SYSTEM OF OPERATION LEVER FOR OPERATING DEVICE

(71) Applicant: INDUSTRY-UNIVERSITY COOPERATION FOUNDATION HANYANG UNIVERSITY ERICA CAMPUS, Ansan-si (KR)

(72) Inventors: Chang Soo HAN, Seoul (KR); Min Sung KANG, Seoul (KR); Seung Hoon LEE, Gwacheon-si (KR); Myeong Su GIL, Ansan-si (KR); Sung Jin LIM, Ansan-si (KR); Si Hwan MOON, Ulsan (KR); Yong Seok LEE, Ansan-si (KR); Sang Ho KIM, Busan (KR)

(21) Appl. No.: 15/110,543

(22) PCT Filed: Feb. 24, 2014
(86) PCT No.: PCT/KR2014/001480

§ 371 Date: Jul. 8, 2016

(30) Foreign Application Priority Data
Jan. 20, 2014 (KR) 10-2014-0006900

(51) Int. Cl. E02F 9/20; G05G 1/00

(52) U.S. Cl. CPC E02F 9/2004; E02F 9/205; G05G 1/00; E02F 3/325

(57) ABSTRACT

An unmanned control system of an operation lever for operating a device includes: a mountable operation unit which is attachably and separably coupled to an operation lever for operating a device and manipulates the operation lever; and an operation unit control part which moves the operation lever coupled to the mountable operation unit by remotely controlling the mountable operation unit, in which the mountable operation unit has the same degree of freedom as the operation lever. The unmanned control system may lower a center of gravity of the mountable operation unit, thereby precisely controlling the operation lever and improving intuition with respect to the movement of the operation lever and the mountable unit.

### TECHNICAL FIELD

The present invention relates to an unmanned control system, and more particularly, to an unmanned control system of an operation lever for operating a device, in which a mountable operation unit is attachably and separably mounted on the existing operation lever, and the operation lever is remotely controlled and manipulated by the mountable operation unit, thereby preventing workers from being exposed to a working environment in which there are a number of risk factors and preventing inconsistency between an operation space of the operation lever and an operation space of the mountable operation unit.

### BACKGROUND ART

In general, construction heavy equipment such as excavators and cranes is widely used in industrial sites, particularly, construction sites. Since an environment in which the construction heavy equipment is used is exposed to a number of risk factors, persons who operate the heavy equipment need to pay particular attention. The reason is that a probability that safety accidents will occur when the person does not pay particular attention is higher than in other industrial field.

Therefore, a plurality of methods is not only taken into account to prevent workers from being subjected to a safety accident while working as described above and to allow the workers to efficiently perform work, but also actually carried out.

One of the methods which are actually carried out is to control an operation of the construction heavy equipment from the outside instead of allowing the worker to get directly in the construction heavy equipment and then to perform work. That is, the method of making the construction heavy equipment unmanned.

In the related art, there are broadly two methods of remotely manipulating the construction heavy equipment in an unmanned manner.

First, as a convertible type, the existing mechanical hydraulic apparatuses are replaced by electro-hydraulic apparatuses so as to remotely manipulate a system itself, and various types of control apparatuses are mounted to control the electro-hydraulic apparatuses.

Second, as a mountable type, a manipulator in the form of a robotic arm is mounted in the existing construction heavy equipment so as to manipulate an operation lever, or a robot such as a humanoid robot is seated in the existing construction heavy equipment instead of the manipulator so as to manipulate the operation lever.

However, in the case of the first-mentioned unmanned control method in a convertible type, there are problems in that it is complicated because of having to completely change the existing mechanical apparatuses to new electro-hydraulic apparatuses, thus the existing system cannot be used, and there is a limitation to the type and the number of applicable apparatuses.

In addition, in the case of the second-mentioned unmanned control method in a mountable type, there are problems in that it is difficult to develop and mount the manipulator or the humanoid robot for manipulating the operation lever, and expensive actuators are required to implement the structure. In addition, there is a problem in that it is difficult for a worker to directly carry the manipulator or the humanoid robot.

Therefore, there is an acute need for development of an unmanned control system with a new structure, which is capable of being applicable to the existing system, being easily portable, and enabling the apparatus such as the heavy equipment to be accurately manipulated remotely from the outside of the apparatus.

To solve the existing problems, the present applicant has proposed Korean Patent Publication No. 10-2011-0074041. However, in the case of the unmanned control system disclosed in the Patent Publication No. 10-2011-0074041, a mountable operation unit is mounted above an operation lever, and as a result, there is spatial restriction when a driver manually operates the operation lever in a state in which the mountable operation unit is mounted. In addition, since the mountable operation unit is positioned above the operation lever, a center of gravity of the operation unit is located above the operation lever, and as a result, there is a limitation in that the operation lever cannot be accurately controlled. In addition, in a case in which the mountable operation unit is attached to the operation lever of the apparatus, the worker may remotely perform work, but there is a problem in that it is difficult for the worker to get in the apparatus and then perform work because of a problem with a volume of the operation unit. Furthermore, due to a problem with a method in which the mountable operation unit is mounted on the operation lever of the apparatus, there are problems in that a large amount of time is needed to mount the operation unit, mechanical mechanisms are complicated, and motion of the operation lever is difficult to be intuitively determined.

### DISCLOSURE

### Technical Problem

An object of the present invention is to provide an unmanned control system of an operation lever for operating a device, in which a mountable operation unit is mounted on the existing operation lever and the mountable operation unit is remotely manipulated, thereby preventing workers from being exposed to a working environment in which there are a number of risk factors and thus preventing the occurrence of a safety accident.

Another object of the present invention is to provide an unmanned control system of an operation lever for operating a device, which allows an operation lever to be manually manipulated without spatial restriction even in a state in which a mountable operation unit is mounted on the operation lever of the device.

Another object to the present invention is to provide an unmanned control system of an operation lever for operating a device, in which a structure of a mountable operation unit is simplified, and thus the mountable operation unit is easily mounted and separated and has excellent portability.

Another object of the present invention is to provide an unmanned control system of an operation lever for operating a device, in which the unmanned control system is capable of accurately controlling an operation lever and improving intuition of motion of the operating lever by lowering a center of gravity of a mountable operation unit.

### Technical Solution

To achieve the aforementioned aspects, an unmanned control system of an operation lever for operating a device according to an exemplary embodiment of the present invention may include: a mountable operation unit which is attachably and separably coupled to an operation lever for operating a device and manipulates the operation lever; and an operation unit control part which moves the operation lever coupled to the mountable operation unit by remotely controlling the mountable operation unit, in which the mountable operation unit may have the same degree of freedom as the operation lever.

The mountable operation unit may include: a link adapter which is separably and attachably mounted on the operation lever; a base adapter which is mounted in a cockpit of the device; and a drive unit which is mounted on the base adapter and operates the link adapter.

The link adapter may include: a guide rod which is connected to the drive unit; a sliding member which slides on the guide rod; a lever fastening member which is coupled to the operation lever; and a link member which connects the lever fastening member and the sliding member.

The link adapter may further include a rotary link member which connects the link member with the sliding member.

The link member may include a support portion which is connected to the lever fastening member, and a connecting portion which extends in a direction parallel to a center of the support portion.

The connecting portion may extend from the support portion in a state in which the connecting portion is eccentric from the center of the support portion.

An inclination compensation member may be provided between the link member and the lever fastening member, and the inclination compensation member may include a parallel maintaining portion which is in contact with the lever fastening member, and an inclination maintaining portion which is in contact with the support portion.

One end of the rotary link member may be rotatably connected to the link member, and the other end thereof may be rotatably connected to the sliding member.

The sliding member may include a linear bushing which moves along the guide rod.

A rotation center of one end of the rotary link member and a rotation center of the other end thereof may be orthogonal to each other.

The guide rod may be formed to have a length which prevents the sliding member from being separated from an upper end of the guide rod.

The base adapter may include a base portion which is fixed to a lever housing in which a lower end of the operation lever is positioned, and a motor support portion which extends from the base portion and on which the drive unit is mounted.

A through hole through which the operation lever passes may be formed in the base portion and a concave stepped portion may be formed between the through hole and an edge of the base portion.

The base portion may further include a clamp which is fastened to an upper end of the lever housing and an edge of the through hole.

The drive unit may include a first motor which is mounted on the motor support portion and a second motor which is provided to be rotatable by driving power of the first motor.

The first motor may be fixedly installed on the motor support portion, and the second motor may be connected to an output shaft of the first motor and rotatably installed on a second motor support portion.

A lower end of the guide rod may be rotatably connected to an output shaft of the second motor.

The output shaft of the first motor may be parallel to a rotation center of the other end of the rotary link member and the output shaft of the second motor may be parallel to a rotation center of one end of the rotary link member.

The link adapter and the base adapter may be connected with the operation lever so as to define a closed linkage.

The mountable operation unit may transmit driving power to the operation lever in a serial manner.

### Advantageous Effects

According to the unmanned control system of an operation lever for operating a device according to the present invention, the mountable operation unit is mounted on the existing operation lever and the mountable operation unit is remotely manipulated, thereby preventing workers from being exposed to a working environment in which there are a number of risk factors and thus preventing the occurrence of a safety accident in advance.

According to the unmanned control system of an operation lever for operating a device according to the exemplary embodiment of the present invention, the mountable operation unit mounted on the operation lever of the device may be accurately manipulated from the outside, thereby improving efficiency and accuracy of work.

According to the unmanned control system of an operation lever for operating a device according to the exemplary embodiment of the present invention, the mountable operation unit has a structure that may be mounted on and used with the existing operation lever, and as a result, the existing system may be utilized as it is, and the operation lever may be manually manipulated even in a state in which the operation unit is mounted.

According to the unmanned control system of an operation lever for operating a device according to the exemplary embodiment of the present invention, the structure of the mountable operation unit is simple, components thereof are easily replaced, and a worker may carry the mountable operation unit.

The unmanned control system of an operation lever for operating a device according to the exemplary embodiment of the present invention may lower a center of gravity of the mountable operation unit, thereby precisely controlling the operation lever and improving intuition with respect to the movement of the operation lever or the mountable unit.

### DESCRIPTION OF DRAWINGS

FIG. 1 is a view schematically illustrating a configuration of an unmanned control system of an operation lever for operating a device according to an exemplary embodiment of the present invention.

FIG. 2 is a perspective view illustrating a mountable operation unit provided to an operation lever of a device according to FIG. 1.

FIGS. 3 and 4 are views illustrating a link adapter of the mountable operation unit according to FIG. 2.

FIGS. 5 to 7 are views illustrating a base adapter and a drive unit of the mountable operation unit according to FIG. 2.

FIG. 8 is a view for explaining an operation of the unmanned control system of an operation lever for operating a device according to the exemplary embodiment of the present invention.

### BEST MODE

Hereinafter, exemplary embodiments according to the present invention will be described in detail with reference to the accompanying drawings. However, the present invention is not restricted or limited by the exemplary embodiments. Like reference numerals indicated in the respective drawings refer to the same constituent elements.

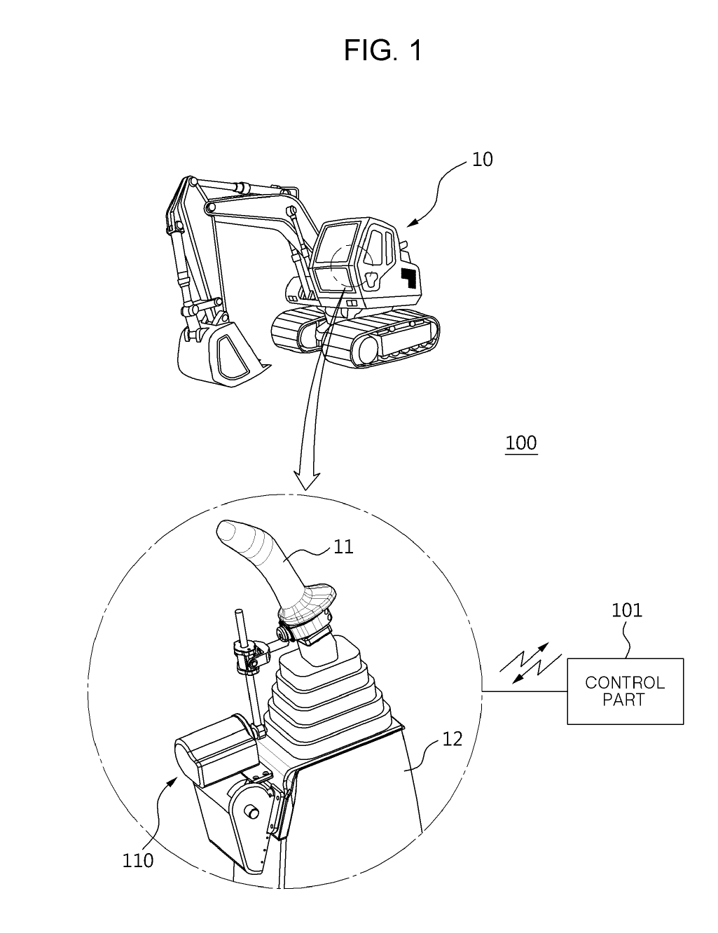

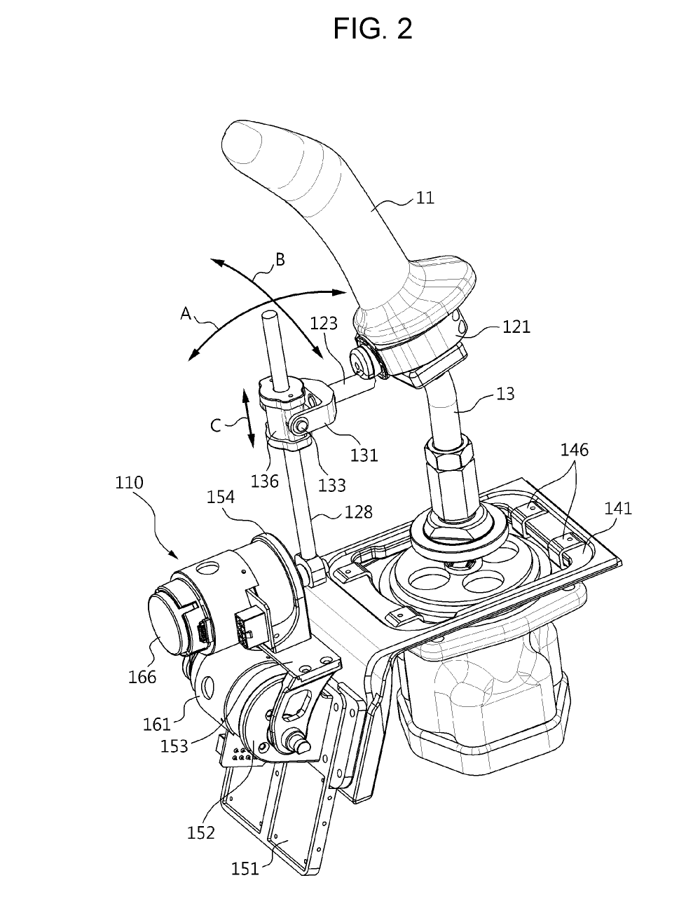

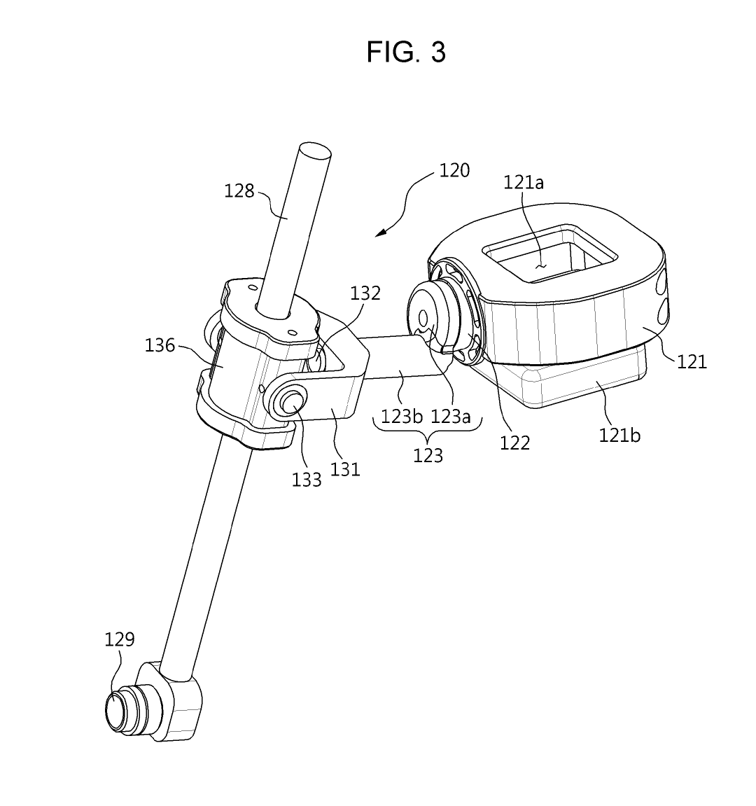

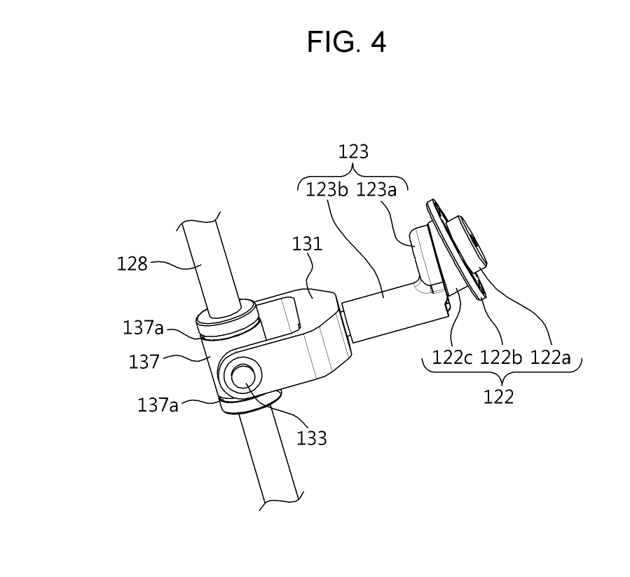

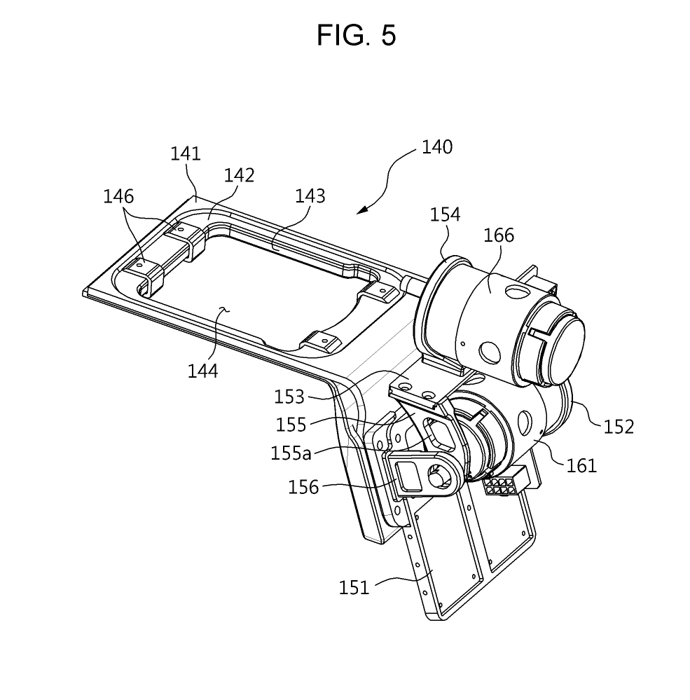

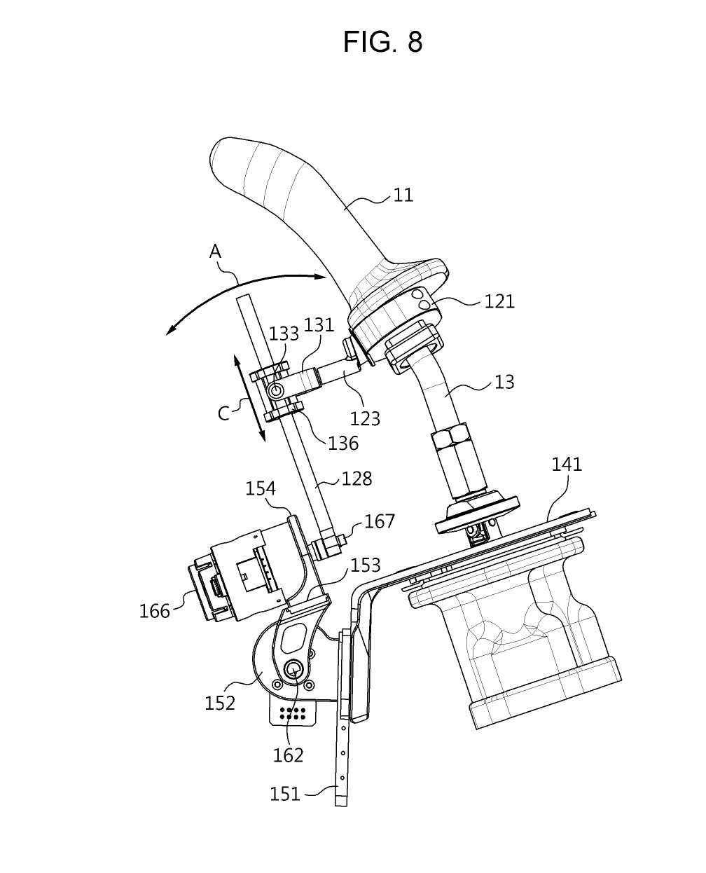

FIG. 1 is a view schematically illustrating a configuration of an unmanned control system of an operation lever for operating a device according to an exemplary embodiment of the present invention, FIG. 2 is a perspective view illustrating a mountable operation unit provided to the operation lever of a device according to FIG. 1, FIGS. 3 and 4 are views illustrating a link adapter of the mountable operation unit according to FIG. 2, FIGS. 5 to 7 are views illustrating a base adapter and a drive unit of the mountable operation unit according to FIG. 2, and FIG. 8 is a view for explaining an operation of the unmanned control system of an operation lever for operating a device according to the exemplary embodiment of the present invention.

As illustrated in FIG. 1, an unmanned control system 100 of an operation lever for operating a device according to an exemplary embodiment of the present invention refers to a system capable of operating an operation lever 11 in an unmanned or manned manner, which is provided in a device 10 such as automobiles as well as construction heavy equipment or construction machines such as excavators or bulldozers.

Hereinafter, the unmanned control system, which is applied to an operation lever mounted in heavy equipment such as excavators or cranes, will be described in detail, but the present invention is not limited thereto, and the unmanned control system according to the present invention may of course is applied to other devices, for example, factory control devices or transportation devices which are operated by the operation levers.

The unmanned control system 100 of an operation lever for operating a device according to the exemplary embodiment of the present invention may include a mountable operation unit 110 which is attachably and separably coupled to the operation lever 11 for operating the device 10 and manipulates the operation lever, and an operation unit control part 101 which adjusts and moves the operation lever 12 coupled to the mountable operation unit 110 by remotely controlling or manipulating the mountable operation unit 110. The mountable operation unit 110 may mean a mounting type operation unit.

Here, the mountable operation unit 110 may have the same degree of freedom (DOF) as the operation lever 11, and may be operated as a serial type. That is, both of the mountable operation unit 110 and the operation lever 11 have two degrees of freedom and have drive mechanisms in a serial type, and this will be described in more detail below.

In general, a lever housing 12 in which a lower end of the operation lever 11 is positioned is formed on a floor in a cockpit of the device, and the lever housing 12 typically protrudes upward from the floor in the cockpit while having a structure for shielding various types of power transmission components connected to the lower end of the operation lever 11.

The unmanned control system 100 of an operation lever for operating a device according to the exemplary embodiment of the present invention may remotely manipulate or control the mountable operation unit 110 by using the operation unit control part 101. That is, with the operation unit control part 101 and the mountable operation unit 110, the device may become unmanned. The operation unit control part 101 and the mountable operation unit 110 may be connected in both wired and wireless manners, and the operation unit control part 101 is preferably provided in a state of being separated from the device 10.

The mountable operation unit 110 of the unmanned control system 100 according to the exemplary embodiment of the present invention may allow a worker to directly and manually manipulate the operation lever 11 even in a state in which the mountable operation unit 110 is mounted on the operation lever 11. That is, in a state in which the mountable operation unit 110 is mounted, the worker may directly and manually manipulate the operation lever 11 in a comparatively free manner without any spatial restriction.

Referring to FIG. 2, in a state in which the mountable operation unit 110 is mounted on the operation lever 11, the operation unit 110 and the operation lever 11 define a closed linkage structure. That is, a link adapter 120 and a base adapter 140 may be connected with the operation lever 11 so as to define the closed linkage.

The mountable operation unit 110 may include the link adapter 120 which is attachably and separably mounted on the operation lever 11, the base adapter 140 which is mounted in the cockpit of the device 10, and drive units 161 and 166 which are mounted on the base adapter 140 and operate the link adapter 120.

The mountable operation unit 110 according to the present invention is entirely positioned below the operation lever 11, and as a result, there is no difficulty in holding and manipulating the operation lever 11 with the hand even in a state in which the mountable operation unit 110 is mounted. In addition, the center of gravity of the mountable operation unit 110 is located at a lower side, thereby improving precision when remotely and automatically controlling the operation lever 11.

The link adapter 120 of the mountable operation unit 110 is a linkage structure for connecting the operation lever 11 and the drive units 161 and 166, and the base adapter 140 is a plate shaped structure for fixing the drive units 161 and 166 to the device 10.

The link adapter 120 is provided with one prismatic passive joint and two revolute passive joint, thereby smoothly operating the operation lever 11.

First, the link adapter 120 may include a guide rod 128 which is connected to the drive units 161 and 166, a sliding member 136 which rectilinearly moves or slides on the guide rod 128 along the guide rod 128, a lever fastening member 121 which is coupled to the operation lever 11, and a link member 123 which connects the lever fastening member 121 and the sliding member 136.

Here, the link adapter 120 may further include a rotary link member 131 which connects the link member 123 with the sliding member 136. The rotary link member 131 may be rotatably connected between the sliding member 136 and the link member 128 so as to prevent the movement of the sliding member 136 on the guide rod 128 from being restricted by the lever fastening member 121 and the link member 123.

As illustrated in FIG. 2, by the rotation of the drive units 161 and 166 mounted on the base adapter 140, the sliding member 136 moves in a forward and rearward direction (indicated by the arrow A), a left and right direction (indicated by the arrow B), and an up and down direction (indicated by the arrow C), and the operation lever 11 is also moved in conjunction with the movement of the sliding member 136.

Referring to FIGS. 2 to 4, a hole 121a which a connecting shaft 13 formed at the lower end of the operation lever 11 penetrates may be formed in the lever fastening member 121, and a fixing unit 121b on which a fastening member (not illustrated) for bringing the lever fastening member 121 into close contact with the operation lever 11 is seated may be formed on the lever fastening member 121. Since the lever fastening member 121 is coupled to the operation lever 11, the lever fastening member 121 moves identically to the operation lever 11.

The link member 123 may include a support portion 123a which is connected to the lever fastening member 121, and a connecting portion 123b which extends in a direction parallel to a center of the support portion 123a. Here, the connecting portion 123b may extend from the support portion 123a in a state in which the connecting portion 123b is eccentric from the center of the support portion 123a.

The link member 123 is a member for connecting the lever fastening member 121 and the rotary link member 131. Since the link member 123 in a state of being fixed is fastened to the lever fastening member 121, the link member 123 also moves similarly to the lever fastening member 121.

It can be seen that when viewing the link member 123 from a lateral side thereof, the support portion 123a and the connecting portion 123b are formed to be bent at an angle of approximately 90 degrees. The reason is to smoothly transmit the movement of the sliding member 136 to the operation lever 11 even in a state in which the operation lever 11 is inclined. The operation lever 11 may sometimes be vertically positioned at a basic position (i.e., a position before starting the device), but may be inclined with respect to the vertical direction when the operation lever 11 is positioned at the basic position. The connecting portion 123b of the link member 123 need not be eccentric if the operation lever 11 is positioned in a vertical state at the basic position, but in a case in which the connecting portion 123b is formed to be eccentric and the operation lever 11 is positioned to be inclined at the basic position, the connecting portion 123b may be more easily connected with the sliding member 136.

The position of the connecting portion 123b with respect to the center of the support portion 123a may be adjusted based on the extent to which the operation lever 11 is inclined and a distance between the guide rod 128 and the operation lever 11.

Meanwhile, an inclination compensation member 122 may be provided between the link member 123 and the lever fastening member 121. As illustrated in FIGS. 3 and 4, the support portion 123a of the link member 123 is not parallel to a lateral side of the lever fastening member 121. Therefore, in this state, the support portion 123a of the link member 123 and the lever fastening member 121 cannot be stably coupled to each other, and as a result, the inclination compensation member 122 is preferably installed between the link member 123 and the lever fastening member 121 so that the link member 123 and the lever fastening member 121 may be securely coupled to each other even in a state in which the support portion 123a of the link member 123 is not parallel but inclined to the lever fastening member 121.

The inclination compensation member 122 may include a parallel maintaining portion 122a which is in contact with the lever fastening member 121, and an inclination maintaining portion 122c which is in contact with the support portion 123a. A flange portion 122b may further be formed between the parallel maintaining portion 122a and the inclination maintaining portion 122c. The flange portion 122b is preferably larger than the parallel maintaining portion 122a and the inclination maintaining portion 122c.

The sliding member 136 may include a linear bushing 137 which moves along the guide rod 128, and a bushing housing (not illustrated) which accommodates the linear bushing 137. The linear bushing 137 performs the same function as a linear bearing which moves along the guide rod 128. Fastening grooves 137a for coupling the bushing housing may be formed in the linear bushing 137.

The guide rod 128 preferably has a length to the extent that the sliding member 136 is not separated from an upper end of the guide rod 128. A motor connecting portion 129, which is rotatably connected to one motor 166 of the drive units 161 and 166, may be formed at a lower end of the guide rod 128. The guide rod 128 is moved by the movement of the drive units 161 and 166 having two degrees of freedom, which is transmitted through the motor connecting portion 129, and the sliding member 136, which is connected to the lever fastening member 121 by means of the link member 123 moves forward and rearward or leftward and rightward while sliding. As a result, the operation lever 11 is remotely moved by the movement of the sliding member 136.

One end 132 of the rotary link member 131, which is connected between the sliding member 136 and the link member 128, may be rotatably connected to the link member 123 and the other end 133 thereof may be rotatably connected to the sliding member 136. Referring to FIGS. 3 and 4, while the one end 132 of the rotary link member 131 is rotatably connected to the link member 123 at a single point, the other end 133 thereof may be rotatably connected to the sliding member 136 at two points.

Meanwhile, a rotation center of the one end 132 of the rotary link member 131 may be orthogonal to a rotation center of the other end 133 thereof. That is, the operation lever 11 may be moved forward and rearward by the rotation of the one end 132 of the rotary link member 131, and the operation lever 11 may be moved leftward and rightward by the rotation of the other end 133 thereof. In addition, during the movements, the sliding member 136 may move upward and downward along the guide rod 128.

Referring to FIGS. 5 to 7, the base adapter 140 may include a base portion 141 which is fixed to the lever housing 12 in which the lower end of the operation lever 11 is positioned, and a motor support portion 151 which extends from the base portion 141 and on which the drive units 161 and 166 are mounted.

Referring to FIGS. 5 to 7, the motor support portion 151 is illustrated as being bent downward from the base portion 141, but the motor support portion 151 need not be necessarily bent downward, and may be formed to be flush with the base portion 141. In addition, the motor support portion 151 and the base portion 141 may be integrally formed, or may be separately formed and then coupled to each other.

However, since the motor support portion 151 is a portion where an object such as a motor, which is heavy in weight, is mounted, it is preferred that the motor support portion 151 is placed at an upper side of a structure which supports the motor support portion 151 at a lower side of the motor support portion 151. Referring to FIG. 1, since the motor support portion 151 is supported by the lever housing 12, the motor support portion 151 is bent downward so as to be supported by the lever housing 12.

A through hole 144 through which the operation lever 11 passes is formed in the base portion 141, and a concave stepped portion 142 may be formed between the through hole 144 and an edge of the base portion 141. The stepped portion 142 is a portion on which a lower end of a rubber cover (not illustrated) installed to the operation lever 11 is seated.

The base portion 141 needs to be securely fixed in the cockpit of the device 10, and to this end, the base portion 141 may further include clamps 146 which are fastened to an upper end of the lever housing 12 and an edge of the through hole 144. The shape or structure of the clamp 146 is not limited to the illustrated shape or structure, and other fastening means may be used instead of the clamp 146.

A vibration pad 143 may be interposed between the base portion 141 and the lever housing 12.

Meanwhile, the drive units 161 and 166 may include a first motor 161 which is mounted on the motor support portion 151, and a second motor 166 which is provided to be rotatable by driving power of the first motor 161. The mountable operation unit 110 according to the exemplary embodiment of the present invention is a serial type manipulator having two degrees of freedom. Therefore, two motors 161 and 166 are needed.

The first motor 161 and the second motor 166 may be installed on the motor support portion 151 so that output shafts 162 and 167 thereof are orthogonal to each other. The first motor 161 is fixedly installed on the motor support portion 151, and the second motor 166 is connected to the output shaft 162 of the first motor 161 and may be rotatably installed on a second motor support portion 153.

The output shaft 162 needs to be rotatable in a state in which the first motor 161 is provided on the motor support portion 151. The first motor 161 is supported by a first support portion 152 provided on the motor support portion 151, and the first support portion 152 supports a portion where the output shaft 162 of the first motor 161 is formed. In this case, the output shaft 162 of the first motor 161 penetrates the first support portion 152, and is supported in a state of being rotatable relative to the first support portion 152.

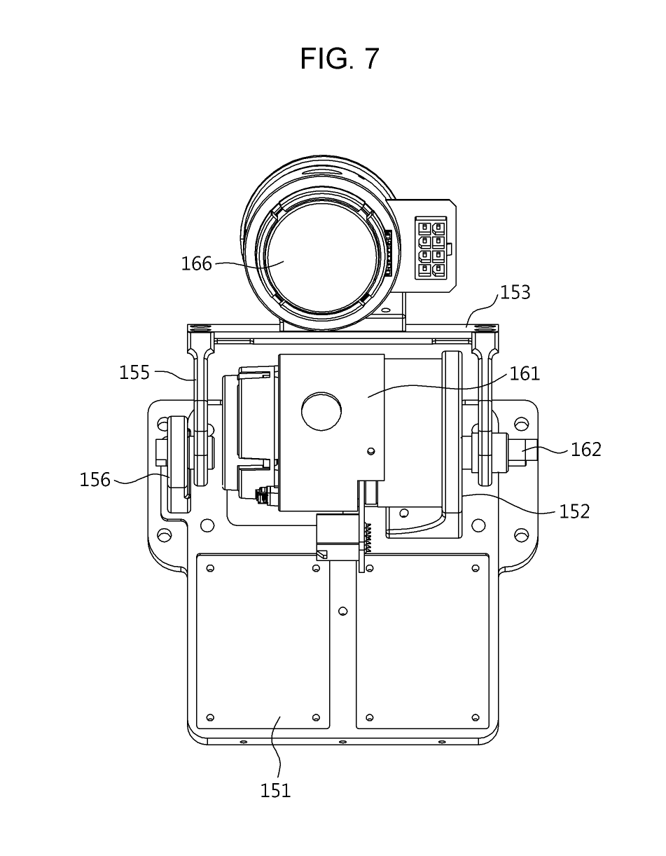

Meanwhile, the second motor 166 needs to be installed to be rotatable by the output shaft 162 of the first motor 161. Referring to FIG. 7, the second motor 166 is placed on a second support portion 158 which is rotatably connected to the output shaft 162 of the first motor 161 outside the first support portion 152. The second support portion 158 may include a plate shaped member 153 on which the second motor 166 is placed, and a rotational force transmission member 157 which is connected to one end of the plate shaped member 153 and connected to the output shaft 162 of the first motor 161 so as to be rotated.

The other end of the plate shaped member 153 may be connected to a driven support member 155 which is formed to be rotatable relative to an auxiliary support member 156 installed on the motor support portion 151.

Referring to FIG. 7, the auxiliary support member 156 is fixed to the motor support portion 151, but never involved in supporting the first motor 161. That is, the auxiliary support member 156 is not connected with the first motor 161, and an interval is provided between the first motor 161 and the auxiliary support member 156.

In FIG. 5, non-described reference numeral 155a indicates a weight reduction hole. That is, the weight reduction hole 155a is formed in the driven support member 155, such that it is possible to reduce an overall weight and production costs of the mountable operation unit 110.

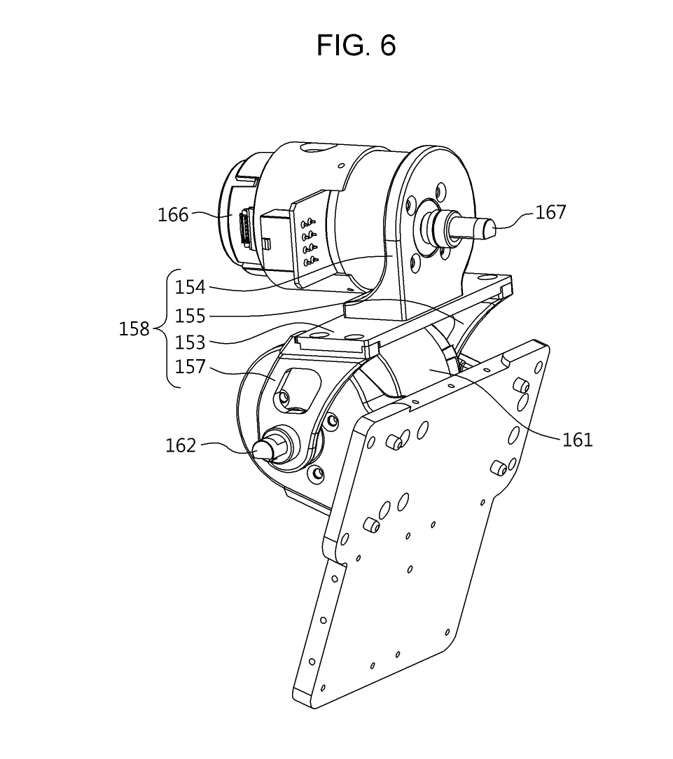

As illustrated in FIG. 6, the second motor 166 is fixed to the plate shaped member 153, and may be fixed to a motor supporting and fixing member 154 that supports a portion where the output shaft 167 of the second motor 166 is formed.

Meanwhile, the lower end of the guide rod 128 may be rotatably connected to the output shaft 167 of the second motor 166. That is, the motor connecting portion 129 formed at the lower end of the guide rod 128 may be connected to the output shaft 167 of the second motor 166. The motor connecting portion 129 may rotate together with the output shaft 167 of the second motor 166.

The output shaft 162 of the first motor 161 may be in parallel with the rotation center of the other end 133 of the rotary link member 131, and the output shaft 167 of the second motor 166 may be in parallel with the rotation center of the one end 132 of the rotary link member 131. Since the output shafts 162 and 167 are formed as described above, the sliding member 136 may be rotated relative to the other end 133 of the rotary link member 131 by the rotation of the output shaft 162 of the first motor 161 (see the arrow A in FIG. 2). In addition, the one end 132 of the rotary link member 131 may be rotated relative to the link member 123 by the rotation of the output shaft 167 of the second motor 166 (see the arrow B in FIG. 2). In addition, the sliding member 136 may move upward and downward along the guide rod 128 while moving forward, rearward, leftward, and rightward by receiving rotational force from the first motor 161 and the second motor 166 (see the arrow C in FIG. 2).

Referring to FIG. 8, according to the unmanned control system 100 of an operation lever for operating a device according to the exemplary embodiment of the present invention, the operation lever 11 may be moved by the mountable operation unit 110 while having two degrees of freedom and has a serial movement mechanism. That is, the two motors 161 and 166, which have the output shafts orthogonal to each other, are provided, such that the two-degree-of-freedom movement may be carried out like the degree of freedom of the operation lever 11. In addition, in a state in which the guide rod 128 has been moved by the first motor 161, the guide rod 128 is further moved by the second motor 166, such that the sliding member 136 may move as a serial type. The mountable operation unit 110 may transmit driving power to the operation lever 11 in a serial manner.

As described above, according to the exemplary embodiment of the present invention, the mountable operation unit 110 is mounted on the operation lever 11 of the device, and the mountable operation unit 110 is remotely manipulated or controlled by the operation unit control part 101, such that it is possible to prevent workers from being exposed to a working environment in which there are a number of risk factors, thereby preventing the occurrence of a safety accident in advance, and improving efficiency and accuracy of work through remote manipulation and remote control.

In addition, the mountable operation unit 110 is constructed to be mounted on and used with the operation lever 11 of the device, such that the existing system may be used as it is, thereby implementing an effect of reducing costs, and the mountable operation unit 110 has a portable structure.

While the exemplary embodiments of the present invention have been described above with reference to particular contents such as specific constituent elements, the limited exemplary embodiments, and the drawings, but the exemplary embodiments are provided merely for the purpose of helping understand the present invention overall, and the present invention is not limited to the exemplary embodiment, and may be variously modified and altered from the disclosure by those skilled in the art to which the present invention pertains. Therefore, the spirit of the present invention should not be limited to the described exemplary embodiments and all of the equivalents or equivalent modifications of the claims as well as the appended claims belong to the scope of the spirit of the present invention.

The present invention may be applied to devices or apparatuses having an operating lever, such as, construction heavy equipments, tower cranes, log loaders, pavers, and vehicle transmissions.

1. An unmanned control system of an operation lever for operating a device comprising:
a mountable operation unit which is attachably and separably coupled to an operation lever for operating a device and manipulates the operation lever; and
an operation unit control part which moves the operation lever coupled to the mountable operation unit by remotely controlling the mountable operation unit,
wherein the mountable operation unit has the same degree of freedom as the operation lever.

2. The unmanned control system of claim 1, wherein the mountable operation unit includes:
a link adapter which is separably and attachably mounted on the operation lever;
a base adapter which is mounted in a cockpit of the device; and
a drive unit which is mounted on the base adapter and operates the link adapter.

3. The unmanned control system of claim 2, wherein the link adapter includes:
a guide rod which is connected to the drive unit;
a sliding member which slides on the guide rod;
a lever fastening member which is coupled to the operation lever; and
a link member which connects the lever fastening member and the sliding member.

4. The unmanned control system of claim 3, wherein the link adapter further includes a rotary link member which connects the link member with the sliding member.

5. The unmanned control system of claim 4, wherein the link member includes a support portion which is connected to the lever fastening member, and a connecting portion which extends in a direction parallel to a center of the support portion.

6. The unmanned control system of claim 5, wherein the connecting portion extends from the support portion in a state in which the connecting portion is eccentric from the center of the support portion.

7. The unmanned control system of claim 6, wherein an inclination compensation member is provided between the link member and the lever fastening member, and the inclination compensation member includes a parallel maintaining portion which is in contact with the lever fastening member and an inclination maintaining portion which is in contact with the support portion.

8. The unmanned control system of claim 6, wherein one end of the rotary link member is rotatably connected to the link member and the other end thereof is rotatably connected to the sliding member.

9. The unmanned control system of claim 8, wherein the sliding member includes a linear bushing which moves along the guide rod.

10. The unmanned control system of claim 8, wherein a rotation center of one end of the rotary link member and a rotation center of the other end thereof are orthogonal to each other.

11. The unmanned control system of claim 3, wherein the guide rod is formed to have a length which prevents the sliding member from being separated from an upper end of the guide rod.

12. The unmanned control system of claim 8, wherein the base adapter includes a base portion which is fixed to a lever housing in which a lower end of the operation lever is positioned, and a motor support portion which extends from the base portion and on which the drive unit is mounted.

13. The unmanned control system of claim 12, wherein a through hole through which the operation lever passes is formed in the base portion, and a concave stepped portion is formed between the through hole and an edge of the base portion.

14. The unmanned control system of claim 13, wherein the base portion further includes a clamp which is fastened to an upper end of the lever housing and an edge of the through hole.

15. The unmanned control system of claim 12, wherein the drive unit includes a first motor which is mounted on the motor support portion and a second motor which is provided to be rotatable by driving power of the first motor.

16. The unmanned control system of claim 15, wherein the first motor is fixedly installed on the motor support portion and the second motor is connected to an output shaft of the first motor and rotatably installed on a second motor support portion.

17. The unmanned control system of claim 16, wherein a lower end of the guide rod is rotatably connected to an output shaft of the second motor.

18. The unmanned control system of claim 17, wherein the output shaft of the first motor is parallel to a rotation center of the other end of the rotary link member and the output shaft of the second motor is parallel to a rotation center of one end of the rotary link member.

19. The unmanned control system of claim 2, wherein the link adapter and the base adapter are connected with the operation lever so as to define a closed linkage.

20. The unmanned control system of claim 1, wherein the mountable operation unit transmits driving power to the operation lever in a serial manner.
